(19) United States
(12) Patent Application Publication
(10) Pub. No.: US 2012/0280976 A1
(43) Pub. Date: Nov. 8, 2012

(54) 3D IMAGE PROCESSING SYSTEM AND METHOD

(75) Inventor: YING-RU CHEN, Tainan City (TW)

(73) Assignee: HIMAX TECHNOLOGIES LIMITED, Tainan City (TW)

(21) Appl. No.: 13/101,706

(22) Filed: May 5, 2011

(51) Int. Cl. G06T 15/00

(52) U.S. Cl. 345/419

(57) ABSTRACT

The invention is directed to a 3D image processing system and method. A depth generator generates a depth map according to a 2D image. A depth-image-based rendering (DIBR) unit generates at least one left image and at least one right image according to the depth map and the 2D image, the DIBR providing hole information and disparity values of pixels according to the depth map. An artifact detection unit locates an artifact pixel location according to the hole information and the disparity values. An artifact reduction unit reduces artifact at the artifact pixel location in the at least one left image and the at least one right image.

### BACKGROUND OF THE INVENTION

1. Field of the Invention

The present invention generally relates to a 3D imaging system, and more particularly to a 3D image processing system and method capable of detecting and reducing artifact.

2. Description of Related Art

FIG. 1 shows a block diagram of a conventional 3D imaging system that creates depth information by a depth generator 10 according to a 2D image input. The depth information, and the 2D image are then processed by depth-image-based rendering (DIBR) 12 to generate a left image (L) and a right image (R), which are then displayed and viewed by a viewer.

As the depth map mentioned, above is commonly derived by some algorithms, discontinuity usually occurs around an image edge. The discontinuity in the depth map may be processed by the DIBR 12 to result in annoying saw-type artifact or error.

For the reason, that conventional 3D imaging system, particularly the system that generates the 3D image based on the depth map derived from the 2D image, could not effectively present 3D image viewing, a need has arisen to propose a novel scheme for reducing the saw-type artifact in the 3D image.

### SUMMARY OF THE INVENTION

In view of the foregoing, it is an object of the embodiment of the present invention to provide a 3D image processing system and method for effectively detecting artifact pixel location and substantially reducing the artifact.

According to one embodiment, a 3D image processing system includes a depth generator, a depth-image-based rendering (DIBR) unit, an artifact detection unit and an artifact reduction unit. The depth generator is configured to generate a depth map according to a 2D image. The depth-image-based rendering (DIBR) unit is configured to generate at least one left image and at least one right image according to the depth map and the 2D image, the DIBR providing hole information and disparity values of pixels according to the depth map. The artifact detection unit is configured to locate an artifact pixel location according to the hole information and the disparity values. The artifact reduction unit is configured to reduce artifact at the artifact pixel location in the at least one left image and the at least one right image.

### BRIEF DESCRIPTION OF THE DRAWINGS

FIG. 1 shows a block diagram of a conventional 3D imaging system;

FIG. 2 shows a block diagram illustrative of a 3D image processing system for reducing artifact in the 3D image according to one embodiment of the present invention;

FIG. 3 shows a flow diagram illustrative of a method of detecting the artifact pixel according to one embodiment of the present invention;

FIG. 4 shows a flow diagram illustrative of a method of determining an edge direction according to one embodiment of the present invention;

FIG. 5A schematically shows some pixels;

FIG. 5B shows the same pixels of FIG. 5A with notation denoting corresponding pixel values; and

FIG. 6 shows a flow diagram illustrative of a method of low-pass filtering the pixels along the edge direction as determined in FIG. 4.

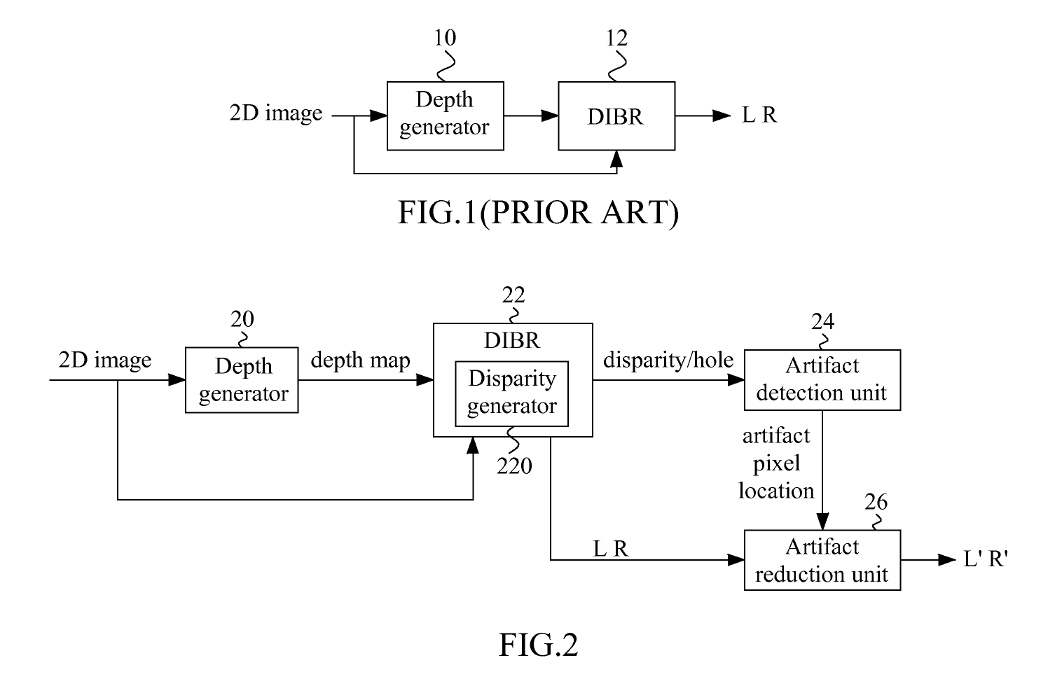

### DETAILED DESCRIPTION OF THE INVENTION

FIG. 2 shows a block diagram illustrative of a three-dimensional (3D) image processing system for reducing artifact (e.g., saw-type artifact) or an error introduced in the 3D image according to one embodiment of the present invention.

In the embodiment, a two-dimensional (2D) image is received by a depth generator 20 that generates a depth map according to the 2D image. In the generated depth map, each pixel or block has its corresponding depth value. For example, an object near a viewer has a greater depth value than an object far from the viewer.

The generated depth map is then forwarded to a depth-image-based rendering (DIBR) unit 22, which generates (or synthesizes) at least one left image (L) and at least one right image (R) according to the depth map and the 2D image. The DIBR unit 22 may be implemented by a suitable conventional technique, for example, as disclosed in a disclosure entitled “A 3D-TV Approach Using Depth-Image-Based Rendering (DIBR),” by Christoph Fehn, the disclosure of which is hereby incorporated by reference. In more detail, the DIBR unit 22 may generate multi-view images including two or more different viewpoint images.

In addition to generating the left and right images, the DIBR unit 22 adopts a disparity generator 220 that is utilized to generate (or derive) disparity values of pixels. In the specification, the term “disparity” (of a pixel) refers to a horizontal difference between the left image and the right image. A viewer can perceive the depth in a 3D image based on the disparity existed between the left image and the right image. The DIBR unit 22 also provides hole information about pixels. In the specification, the term “hole” refers to a pixel that is not assigned an appropriate pixel value.

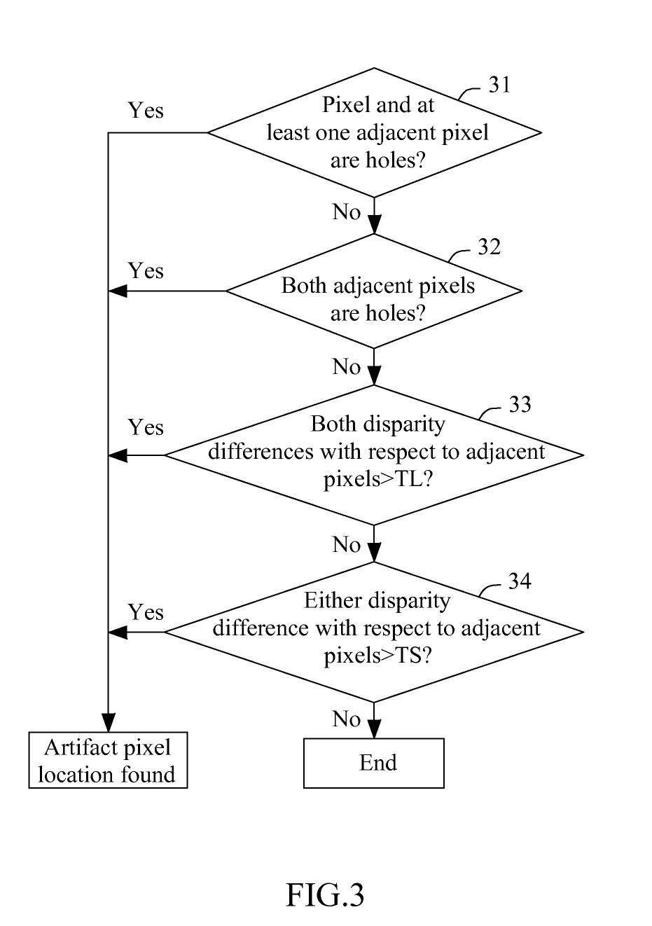

Subsequently, an artifact (e.g., saw-type artifact) detection unit 24 is coupled to receive the disparity values and/or the hole information, based on which an artifact pixel location or locations may be located. FIG. 3 shows a flow diagram illustrative of a method of detecting the artifact pixel located on the left image or the right image according to one embodiment of the present invention. It is noted that the order of performing the steps 31-34 may be altered in another embodiment. In step 31, a decision is made to determine whether a current pixel (to be determined) located on the left image or the right image and at least one adjacent pixel are holes. The decision of step 31 may be expressed as follows:

if (hole(i,j)==1& (hole(i,j−1==1∥ (hole(i,j+1)==1),

where a logic true value (“1”) of hole( ), provided by the DIBR unit 22, indicates that the hole exists, and a logic false value (“0”) of hole(J indicates that no hole exists.

If it is determined that the condition of step 31 has been met, the current pixel location, is determined as an artifact pixel location, indicating that it is very likely that an artifact (e.g., saw-type artifact) may exist at the current pixel. Otherwise, the flow proceeds to next step 32.

In step 32, a decision, is made to determine whether both adjacent pixels neighboring to the current pixel are holes. The decision of step 32 may be expressed as follows:

if (hole(i,j−1)==1 && hole(i,j+1)==1).

If it is determined that the condition of step 32 has been met, the current pixel location, is determined as an artifact pixel location, indicating that it is very likely that an artifact (e.g., saw-type artifact) may exist at the current pixel. Otherwise, the flow proceeds to next step 33.

In step 33, a decision is made to determine whether absolute disparity differences between the current pixel with respect to both adjacent pixels respectively are greater than a predetermined first threshold value TL. The decision of step 33 may be expressed, as follows:

if (abs(disparity(i,j)−disparity(i,j−1))>TL &&

abs(disparity(i,j)−disparity(i,j−1)>TL),

where disparity( ) gives a disparity value provided by the DIBR unit 22.

If it is determined that the condition of step 33 has been met, the current pixel location is determined as an artifact pixel location, indicating that it is very likely that an artifact (e.g., saw-type artifact) may exist at the current pixel. Otherwise, the flow proceeds to next step 34.

In step 34, a decision is made to determine whether an absolute disparity difference between the current pixel with respect to either adjacent pixel is greater than a predetermined second threshold value TS. It is noted that, in the embodiment, the first threshold value TL is smaller than the second threshold value TS.

The decision of step 34 may be expressed as follows:

if (abs(disparity(i,j)−disparity(i,j−1))>TS∥

abs(disparity(i,j)−disparity(i,j−1))>TS).

If it is determined that the condition of step 34 has been met, the current pixel location is determined as an artifact pixel location, indicating that it is very likely that an artifact (e.g., saw-type artifact) may exist at the current pixel. Otherwise, the flow stops.

Subsequently, the left image (L) and the right image (R) generated by the DIBR unit 22 and the artifact pixel location, if any, detected by the artifact detection unit 24 are fed to an artifact reduction unit 26, which accordingly reduces or even eliminates the artifact or the error at the detected artifact pixel location in the left and right images, thereby outputting a resultant left image (L′) and a resultant right image (R′) that are ready for 3D displaying and viewing.

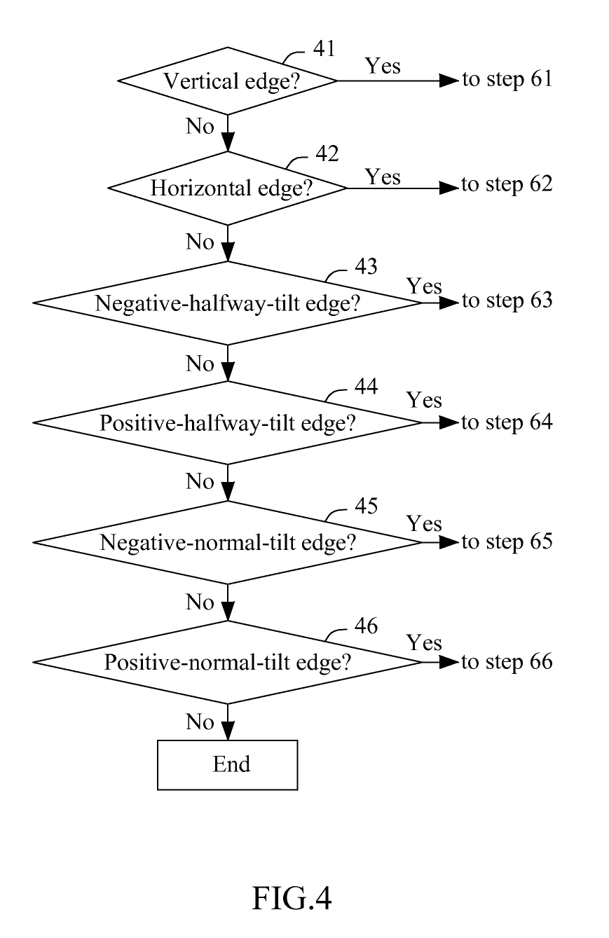

Before performing the artifact reduction, the artifact reduction unit 26 determines a specific direction or angle, along which the artifact reduction may be performed thereafter. FIG. 4 shows a flow diagram illustrative of a method of determining an (image) edge direction according to one embodiment of the present invention. It is noted that the order (or priority) of performing steps 41-46 may be alternated in another embodiment. It is also noted that the flow diagram may be adapted to the left image (L), while the flow diagram adaptable to the right image (R) may be obtained by exchanging steps 43 and 44, and exchanging steps 45 and 46. Specifically speaking, referring to FIG. 4, in step 41, a decision is made to determine whether a vertical edge exists. The decision of step 41 may be expressed as follows:

horizontal brightness difference>vertical brightness difference+T1,

where T1 is a predetermined threshold value, and horizontal (/vertical) brightness difference refers to the brightness difference between horizontally (/vertically) located pixels.

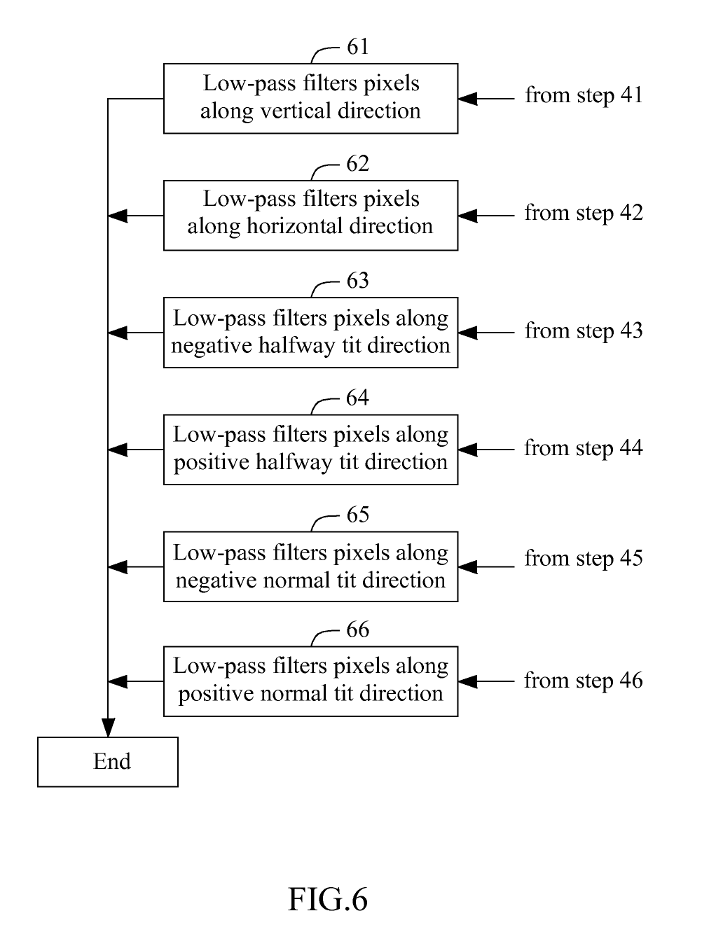

If it is determined that the condition of step 41 has been met, the vertical edge exists and the flow proceeds to step 61 of FIG. 6. Otherwise, the flow proceeds to next step 42.

In step 42, a decision is made to determine whether a horizontal edge exists. The decision of step 42 may be expressed, as follows:

vertical brightness difference>horizontal brightness difference+T2,

where T2 is a predetermined threshold value.

If it is determined that the condition of step 42 has been met, the horizontal edge exists and the flow proceeds to step 62 of FIG. 6. Otherwise, the flow proceeds to next step 43.

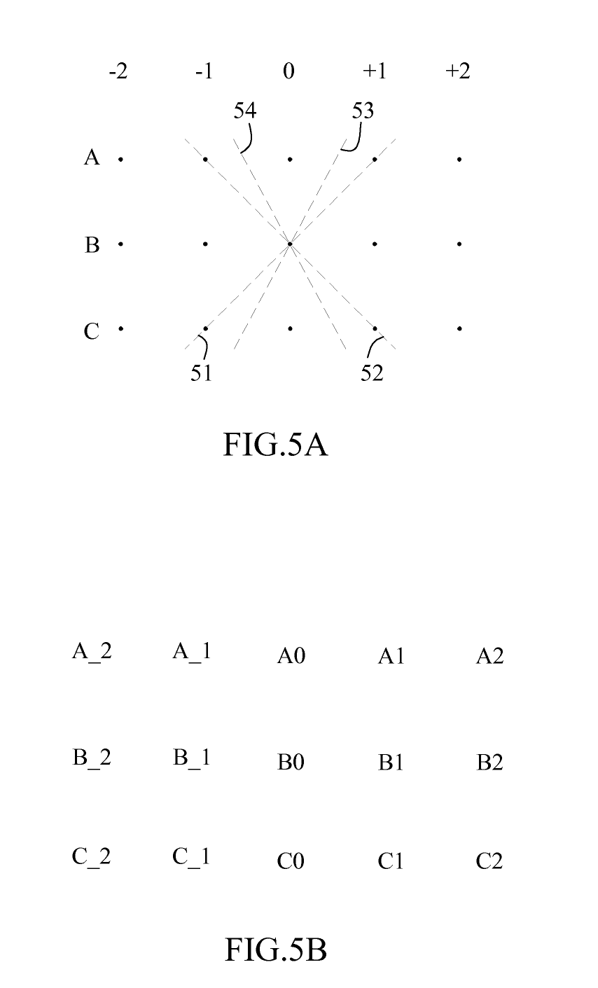

FIG. 5A schematically shows some pixels arranged in row A, row B and row C with horizontal notation denoted, from left to right, by −2, −1, 0, +1 and +2. FIG. 5B shows the same pixels of FIG. 5A with notation denoting corresponding pixel values. If the current pixel is at B(0), the vertical direction is defined as the direction connecting with A(0) and C(0), and the horizontal direction is defined as the direction connecting with B(−1) and B(+1). A positive normal tilt direction 51 is defined in the specification as the direction connecting with a top-right pixel A(+1) and a bottom-left pixel C(−1); and a negative normal tilt direction 52 is defined as the direction connecting with a top-left pixel A(−1) and a bottom-right pixel C(−1). A positive halfway tilt direction 53 is further defined as the direction midway between the vertical direction and the positive normal tilt direction 51, and a negative halfway tilt direction 54 is defined as the direction midway between the vertical direction and the negative normal tilt direction 52.

Referring back to FIG. 4, in step 43, a decision is made to determine whether a negative-halfway-tilt edge exists. The decision of step 43 may be expressed as follows:

negative-halfway-tilt brightness difference<min(horizontal brightness difference,vertical brightness difference)+T3,

where T3 is a predetermined threshold value, min( ) is a minimum operator, and the negative-halfway-tilt brightness difference refers to the brightness difference between pixels along the negative halfway tilt direction.

If it is determined that the condition of step 43 has been met, the edge along the negative halfway tilt direction exists and the flow proceeds to step 63 of FIG. 6. Otherwise, the flow proceeds to next step 44.

In step 44, a decision is made to determine whether a positive-halfway-tilt edge exists. The decision of step 44 may be expressed as follows:

positive-halfway-tilt brightness difference<min(horizontal brightness difference,vertical brightness difference)+T4,

where T4 is a predetermined threshold value, and the positive-halfway-tilt brightness difference refers to the brightness difference between pixels along the positive halfway tilt direction.

If it is determined that the condition of step 44 has been met, the edge along the positive halfway tilt direction exists and the flow proceeds to step 64 of FIG. 6. Otherwise, the flow proceeds to next step 45.

In step 45, a decision is made to determine whether a negative normal tilt edge exists. The decision of step 45 may be expressed as follows:

negative-normal-tilt brightness difference<min(horizontal brightness difference,vertical brightness difference)+T5,

where T5 is a predetermined threshold value, and the negative-normal-tilt brightness difference refers to the brightness difference between pixels along the negative normal tilt direction.

If it is determined that the condition of step 45 has been met, the edge along the negative normal tilt direction exists and the flow proceeds to step 65 of FIG. 6. Otherwise, the flow proceeds to next step 46.

In step 46, a decision is made to determine whether a positive normal tilt edge exists. The decision of step 46 may be expressed as follows:

positive-normal-tilt brightness difference<min(horizontal brightness difference,vertical brightness difference)+T6,

where T6 is a predetermined threshold value, and the positive-normal-tilt brightness difference refers to the brightness difference between pixels along the positive normal tilt direction.

If it is determined that the condition of step 46 has been met, the edge along the positive normal tilt direction exists and the flow proceeds to step 66 of FIG. 6. Otherwise, the flow stops.

After determining the edge direction, the artifact reduction unit 26 then performs the artifact reduction on the pixels along the determined edge direction. In the embodiment, a low-pass filtering is adopted in the artifact reduction unit 26 to reduce the artifact. FIG. 6 shows a flow diagram illustrative of a method of low-pass filtering the pixels located on the artifact pixel location along the edge direction as determined in FIG. 4. In the description discussed below, the pixel B(0) (FIG. 5A) is assumed to be the current pixel. Specifically, in step 61, a number of pixels (e.g., three pixels) along the vertical direction are low-pass filtered. For example, a resultant pixel may be expressed as: (A0*Wa+B0*Wb+C0*Wc)/T, where Wa, Wb and Wc are weightings of the pixels A0, B0 and C0 respectively, and Wa+Wb+Wc=T, T is a constant.

In step 62, a number of pixels (e.g., five pixels) along the horizontal direction are low-pass filtered. For example, a resultant pixel may be expressed, as: (B_{—}2*W_{—}2+B_{—}1*W_{—}1+B0*W0+B1*W1+B2*W2)/T, where W_{—}2, W_{—}1, W_{—}0, W1 and W2 are weightings of the pixels B_{—}2, B_{—}1, B0, B1 and B2 respectively, and W_{—}2+W_{—}1+W0+W1+W2=T.

In step 63, a number of pixels (e.g., five pixels) along the negative halfway tilt direction 54 are low-pass filtered. For example, a resultant pixel may be expressed as: (A_{—}1*W_{—}1+A0*WA0+B0*WB0+C0*WC0+C1*W1)/T, where W_{—}1, WA0, WB0, WC0 and W1 are weightings of the pixels A_{—}1, A0, B0, C0 and C1 respectively, and W_{—}1+WA0+WB0+WC0+W1=T.

In step 64, a number of pixels (e.g., five pixels) along the positive halfway tilt direction 53 are low-pass filtered. For example, a resultant pixel may be expressed as: (C_{—}1*W_{—}1+C0*WC0+B0*WB0+A0*WA0+A1*W1)/T, where W_{—}1, WC0, WB0, WA0 and W1 are weightings of the pixels C_{—}1, C0, B0, A0 and A1 respectively, and W_{—}1+WC0+WB0+WA0+W=T.

In step 65, a number of pixels (e.g., three pixels) along the negative normal tilt direction 52 are low-pass filtered. For example, a resultant pixel may be expressed as: (A_{—}1*W_{—}1+B0*W0+C1*W1)/T, where W_{—}1, W0 and W1 are weightings of the pixels A_{—}1, B0 and C1 respectively, and W_{—}1+W0+W1=T.

In step 66, a number of pixels (e.g., three pixels) along the positive normal tilt direction 51 are low-pass filtered. For example, a resultant pixel may be expressed as: (C_{—}1*W_{—}1+B0*W0+A1*W1)/T, where W_{—}1, W0 and W1 are weightings of the pixels C_{—}1, B0 and A1 respectively, and W_{—}1+W0+W1=T.

Although specific embodiments have been illustrated and described, it will be appreciated by those skilled in the art that various modifications may be made without departing from the scope of the present invention, which is intended to be limited solely by the appended claims.

What is claimed is:

1. A 3D image processing system, comprising:
a depth generator configured to generate a depth map according to a 2D image;
a depth-image-based rendering (DIBR) unit configured to generate at least one left image and at least one right image according to the depth map and the 2D image, the DIBR providing hole information and disparity values of pixels according to the depth map;
an artifact detection unit configured to locate an artifact pixel location according to the hole information and the disparity values; and
an artifact reduction unit configured to reduce artifact at the artifact pixel location in the at least one left image and the at least one right image.

2. The system of claim 1, wherein the artifact pixel location is located by the artifact detection unit according to the following decision:
determining whether a current pixel and at least one adjacent pixel are holes.

3. The system of claim 1, wherein the artifact pixel location is located by the artifact detection, unit according to the following decision:
determining whether both adjacent pixels neighboring to a current pixel are holes.

4. The system of claim 1, wherein the artifact pixel location is located by the artifact detection unit according to the following decision:
determining whether absolute disparity differences between a current pixel with respect to both adjacent pixels respectively are greater than a predetermined first threshold value.

5. The system of claim 1, wherein the artifact pixel location is located, by the artifact detection unit according to the following decision:
determining whether absolute disparity difference between a current pixel with respect to either adjacent pixel is greater than predetermined second threshold value.

6. The system of claim 1, wherein the artifact reduction is performed by the artifact reduction unit according to the following steps:
determining an edge direction; and low-pass filtering the pixels located on the artifact pixel location along the determined, edge direction.

7. The system of claim 6, wherein the edge direction is one of the following: a vertical edge, a horizontal edge, a negative-halfway-tilt edge, a positive-halfway-tilt edge, a negative-normal-tilt edge and a positive-normal-tilt edge.

8. The system of claim 1, wherein the DIBR unit comprises a disparity generator configured to generate the disparity values.

9. A 3D image processing method comprising:
generating a depth map according to a 2D image;
generating at least one left image and at least one right image according to the depth map and the 2D image by depth-image-based rendering (DIBR);
providing hole information and disparity values of pixels
according to the depth map by the DIBR;
locating an artifact pixel location according to the hole information, and the disparity values; and
reducing artifact at the artifact pixel location in the at least one left image and the at least one right image.

10. The method of claim 9, wherein the artifact pixel location is located according to the following decision:
determining whether a current pixel and at least one adjacent pixel are holes.

11. The method of claim 9, wherein, the artifact pixel location is located, according to the following decision:
determining whether both adjacent pixels neighboring to a current pixel are holes.

12. The method of claim 9, wherein the artifact pixel location is located according to the following decision:
determining whether absolute disparity differences between a current pixel with respect to both adjacent pixels respectively are greater than a predetermined first threshold value.

13. The method of claim 9, wherein the artifact pixel location is located according to the following decision:
determining whether absolute disparity difference between a current pixel with respect to either adjacent pixel is greater than predetermined second threshold value.

14. The method of claim 9, wherein the artifact reduction is performed according to the following steps:
determining an edge direction; and
low-pass filtering the pixels located on the artifact pixel location along the determined edge direction.

15. The method of claim 14, wherein the edge direction is one of the following: a vertical edge, a horizontal edge, a negative-halfway-tilt edge, a positive-halfway-tilt edge, a negative-normal-tilt edge and a positive-normal-tilt edge.
